(19) United States
(12) Patent Application Publication
(10) Pub. No.: US 2026/0241854 A1
(43) Pub. Date: Aug. 20, 2026

(54) LIGHT BEAM MARKING SYSTEM AND METHOD FOR VEHICLE VISUAL BLIND ZONES

(71) Applicant: Yen-Wei CHEN, Taoyuan City (TW)

(72) Inventor: Yen-Wei CHEN, Taoyuan City (TW)

(21) Appl. No.: 19/215,653

(22) Filed: May 22, 2025

(30) Foreign Application Priority Data
Feb. 14, 2025 (TW) 114201558

(51) Int. Cl. B60Q 1/24; B60Q 1/00; B60Q 5/00

(52) U.S. Cl. CPC B60Q 1/247; B60Q 1/0023; B60Q 5/006; B60Q 2400/50

(57) ABSTRACT

A light beam marking system and method for vehicle visual blind zones is disclosed. The system primarily comprises a control module and a warning module. Through pre-configuration and operation by the driver of a medium or large vehicle, the system enables the projection of light beam patterns, visual warnings, or audio signals toward external persons or vehicles approaching or located within the vehicle's visual blind spot areas during driving or parking. This mechanism serves to alert such persons or vehicles of their presence within or near the blind spot zones, thereby prompting them to consciously make avoidance decisions, such as steering clear or moving away from the indicated area, in order to reduce the risk of subsequent traffic accidents. Besides, the invention integrates a software application that can be installed on a handheld communication device. Through this application, users may remotely configure, calibrate, or monitor the light beam marking system, allowing for real-time adjustments based on environmental conditions, vehicle type, or user preferences.

### BACKGROUND OF THE INVENTION

### 1. Field of the Invention

The present invention provides a light beam marking system and method for vehicle visual blind zones, particularly suitable for medium to large-sized vehicles. The system is designed to detect the presence or proximity of external objects—such as pedestrians, bicycles, or smaller vehicles—within or near the visual blind spot areas of the host vehicle. Upon detection, the system activates one or more beam projection units, such as projected light beams or illuminated signals, to visually alert both the vehicle driver and the nearby individuals. In addition, the system may also emit an audible warning to further enhance situational awareness and prevent potential collisions or other accidents.

One aspect of the invention includes a warning module, which comprises a combination of beam projection units, dynamic sensing units, proximity detection units, a sound output unit, mist spreading units, and projection drive units, to monitor the space adjacent to the vehicle. Upon identifying an approaching object within a predefined proximity, the control module triggers the beam projection unit to issue visual warnings directly onto the road surface or nearby environment and ensures that external persons or drivers receive immediate and intuitive visual cues about potential danger zones around the vehicle.

Another feature of the invention is the integration of an application software that can be installed on a portable communication device, such as a smartphone or tablet, etc. Through this application, users may remotely configure, calibrate, or monitor the projection units of this beam marking system, allowing for real-time adjustments based on environmental conditions, vehicle type, or user preferences.

Overall, the present invention aims to enhance traffic safety by providing a dual-alert mechanism—both visual and auditory—targeting not only the vehicle operator but also external road users, while maintaining ease of configuration through platform of modern mobile communicating devices.

### 2. Description of Related Art

With the rapid advancement of modern technology, significant improvements have been made in many aspects of daily life, particularly in logistics and transportation, which are essential to human survival and economic development. Among the various modes of transportation, medium and large-sized vehicles play a crucial role in the movement of goods and materials. As such, ensuring the safety of these vehicles, as well as their safe interaction with surrounding road users, has become increasingly important.

As mentioned above, medium and large-sized vehicles are indispensable in logistics and transportation; however, they also present substantial operational challenges and limitations in road traffic. During vehicle start-up, acceleration, deceleration, stopping, turning, emergency braking, or low-speed creeping, such vehicles frequently enter into spatial proximity with other road users, including pedestrians, cyclists, and smaller vehicles. The risk of collision is particularly elevated due to the dynamic and ever-changing nature of the blind spot zones surrounding the vehicle, which are difficult for the driver to monitor in real-time.

These vehicles, due to their large loading capacity and considerable inertia, inherently possess extensive blind spot areas around the front, rear, and sides—areas that are often outside the direct field of vision of the driver. This makes them especially prone to accidents caused by blind spot obstructions or human oversight. Therefore, it is critically important to provide effective methods for alerting the driver about dynamic blind spot changes, and even more importantly, to implement active and intelligent systems that can warn nearby individuals or vehicles to avoid entering or lingering in these danger zones. Actions such as detouring, stopping, or quickly moving away from the vehicle can significantly reduce the risk of accidents.

In view of the aforementioned issues and the vital need for enhanced awareness regarding the blind spot risks associated with medium and large-sized vehicles, the inventor of the present invention has developed a beam indication system for vehicle blind spots. This system is designed to be widely applicable across various types of medium and large vehicles to prevent traffic accidents by improving both driver awareness and external warnings for surrounding road users.

Thus, for the purpose of providing a light beam marking system and method for vehicle visual blind zones that meets the need for certain desired performance and effectiveness by allowing for easy operation and installation by users or vehicle drivers, the present inventor has been devoted himself to study and design in order to provide such convenience and progress applied in medium to large-sized vehicles. This is the motivation of creation of the present invention.

### SUMMARY OF THE INVENTION

The primary objective of the present invention is to provide a light beam marking system and method for vehicle visual blind zones. The core system architecture integrates a control module and a warning module. The whole body of the control module is configured within a box inside the vehicle, allowing the driver to operate the system. The control module further includes a wired control unit, a wireless control unit, and an input/output operation unit.

Meanwhile, the invention is powered by the vehicle's onboard power supply. The wired control unit is connected to the warning module via a data cable and is equipped with input/output ports (e.g., USB-C jacks) that enable bidirectional data transmission for purposes such as firmware updates, system log recording, and device registration information access.

Furthermore, the wireless control unit communicates with an external handheld communication device via Bluetooth or other communication mode, allowing the driver to use an application software (App) to interact with the system. This enables the beam projection angles or direction to be adjusted conveniently with higher precision, aligning with the driver's natural posture and field of view during normal driving conditions. The wireless control unit also supports bidirectional communication through the same mobile application for advanced operations such as firmware updates, system log management, and access to device registration information, thereby enabling refined customization of various optical projection parameters within the system. The input/output operation unit includes physical buttons that allow users to enter system commands and select input operations. It is also equipped with power/status indication lights to convey the system's operational state.

The warning module further comprises a plurality of beam projection units, a plurality of dynamic sensing units, a plurality of proximity detection units, a sound output unit, a plurality of mist spreading units, and a plurality of projection drive units. The plurality of beam projection units is installed based on functional requirements at locations such as the lower of the vehicle's side mirrors. The driver (or vehicle owner) may determine whether to install additional beam projection units at the midsection or other positions of the vehicle, depending on the size of the medium or large-sized vehicle, in order to achieve optimal warning coverage.

Each of the beam projection units includes optical lenses and is configured to project specific warning pattern shapes onto the ground via said lenses, thereby visually marking the spatial range corresponding to the driver's visual blind zones. These visual markings serve to alert external road users or vehicles that may be approaching or entering the blind zones or spot area.

The dynamic sensing units are embedded within the warning module and are capable of detecting various dynamic, quantifiable data related to different parts of the vehicle. This data is transmitted to the aforementioned control module for the purpose of triggering projection events based on vehicle dynamic movement and attitudes.

The proximity detection units are configured to detect whether a person, vehicle, or object enters a predefined blind zones or area. Upon detection, the corresponding data or signal is sent to the control module to determine the timing for triggering the beam projection.

The mist spreading units are arranged in coordination with the beam projection units and are capable of releasing water mist along the beam's projection path. This enhances the visibility and effectiveness of the laser beam through the Tyndall effect, thereby improving the overall warning effect.

The projection drive units serve as the power mechanisms that support and control the beam projection units. They receive operational commands from the input/output operation unit or are controlled via the mobile application software through the wireless control unit, allowing adjustment of the light beam projection angle and direction.

The sound output unit generates corresponding warning sounds based on various triggering conditions determined by the system for activating the beam projection units.

The present invention relates to a light beam marking system and method for vehicle visual blind zones. The core system architecture primarily comprises the integrated structural design of a control module and a warning module. The control module further includes a wired control unit, a wireless control unit, and an input/output operation unit. The warning module further comprises a plurality of beam projection units, a plurality of dynamic sensing units, a plurality of proximity detection units, a sound output unit, a plurality of mist spreading units, and a plurality of projection drive units.

The objective of this invention is to assist drivers of medium and large vehicles—vehicles that are prone to having significant blind zones or area due to their size and structure—by providing a physical system capable of projecting visible beams and image patterns onto the ground or space corresponding to the blind zones. This system enhances situational awareness through a combination of visual and auditory indicators, including but not limited to: beam flickering, flicker frequency, flicker intensity, projected pattern shapes, and audible alerts.

By implementing this system, the medium or large vehicle equipped with the invention can visually mark its blind spot areas in real-time during specific driving conditions, such as vehicle start-up, stopping during motion, emergency braking, acceleration, turning at high or low speeds, or sudden deceleration—situations in which the risk of spatial proximity to other road users (pedestrians or vehicles) is significantly increased.

These visual blind zones indications are based on pre-set configurations by the driver and dynamic calculations performed by the system, enabling real-time visualization of high-risk zones on the vehicle's exterior surroundings or the ground. The purpose is to actively warn other road users of the presence of blind spots and prompt them to consciously avoid entering, staying within, or approaching these zones, thereby reducing the risk of traffic collisions or accidents. The dynamic and instantaneous nature of the vehicle's blind zones necessitate active and intentional avoidance behavior.

In order to provide a more concrete understanding of the aforementioned objects, effects, and features of the present invention, a detailed description is provided below with reference to the accompanying drawings:

### BRIEF DESCRIPTION OF THE DRAWINGS

FIG. 1 is a schematic illustration showing the block diagram of the present invention;

FIG. 2 is a schematic diagram illustrating a partial structural operation of the present invention;

FIG. 3 is a schematic diagram illustrating another partial structural operation of the present invention;

FIG. 4 is a schematic diagram illustrating the external structure of the present invention;

FIG. 5 is a perspective view showing the main page of the application software operated in the external handheld communication device;

FIG. 6 is a perspective view showing one of the subpages of the application software operated in the external handheld communication device.

The elements or parts list of this invention:

1 ′ Light beam marking system and
method for vehicle visual blind zones
10 ′ Control module
11 ′ Wired control unit
12 ′ Wireless control unit
13 ′ Input/Output operation unit
20 ′ Warning module
21 ′ Beam projection units
22 ′ Dynamic sensing units
23 ′ Proximity detection units
24 ′ Sound output unit
25 ′ Mist spreading units
26 ′ Projection drive units
27 ′ Camera button
2101 ′ Local beam projection unit
2102 ′ Local beam projection unit
2103 ′ Local beam projection unit
2104 ′ Local beam projection unit
2105 ′ Local beam projection unit
2201 ′ Local dynamic sensing unit
2202 ′ Local dynamic sensing unit
2301 ′ Local proximity detection unit
2302 ′ Local proximity detection unit
2501 ′ Local mist spreading unit
2601 ′ Local projection drive unit
2602 ′ Local projection drive unit
2603 ′ Local projection drive unit
2604 ′ Local projection drive unit
2605 ′ Local projection drive unit
2701 ′ Beam projection angle scroll bar
2702 ′ Beam projection direction scroll bar
21011 ′ Access button
21021 ′ Access button
21031 ′ Access button
21041 ′ Access button
21051 ′ Access button

### DETAILED DESCRIPTION OF THE PREFERRED EMBODIMENTS

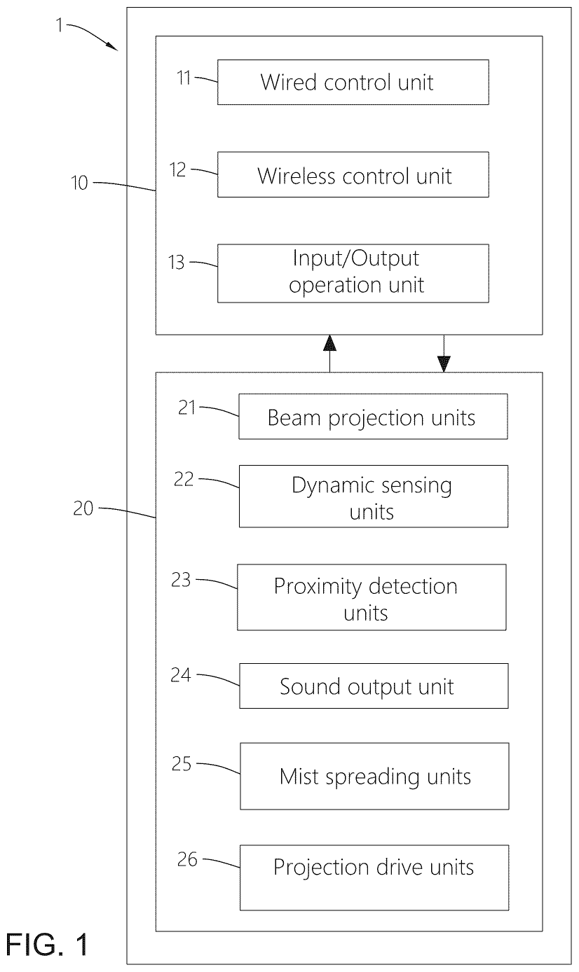

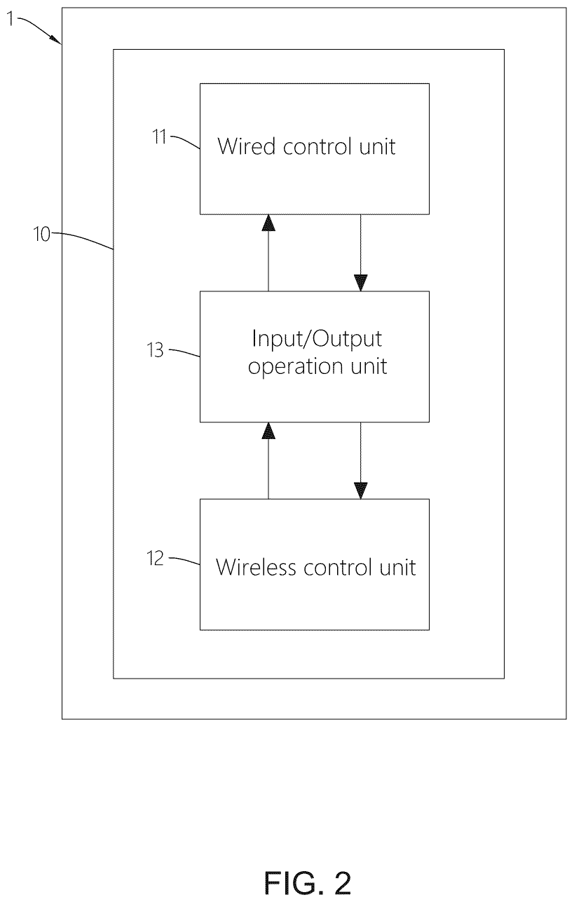

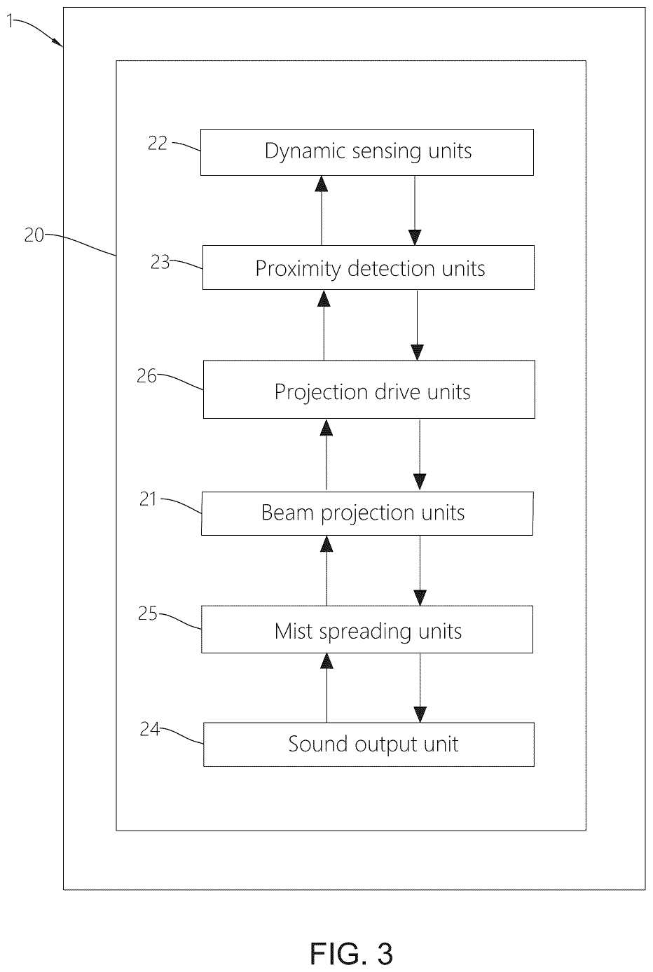

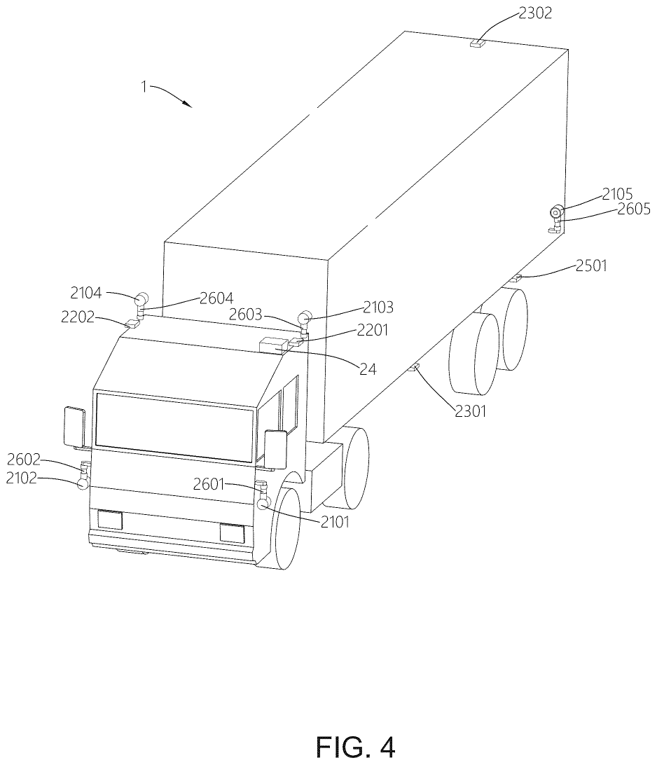

Referring to FIGS. 1 through 6, the primary objective of the present invention is to provide a light beam marking system and method for vehicle visual blind zones 1. The system's main structural design comprises a control module 10 and a warning module 20. The control module 10 is embodied as a control box installed inside the vehicle, enabling the driver to operate and configure the system.

The control module 10 further comprises a wired control unit 11, a wireless control unit 12, and an input/output operation unit 13. The invention utilizes the vehicle's onboard power supply. The wired control unit 11 is connected to the aforementioned warning module via a data cable and includes input/output ports (e.g., USB-C) to allow for firmware updates, system log recording, and device registration information exchange via bidirectional data transmission.

Additionally, the wireless control unit 12 connects externally to a handheld communication device via Bluetooth using a dedicated application software (App), allowing the driver to make more precise adjustments and system control based on driving posture and viewing angle. The wireless control unit 12 can also perform firmware updates, system log management, and device registration data exchange through the app, supporting advanced fine-tuning of customizable optical parameters within the system. The input/output operation unit 13 provides physical buttons for issuing system commands and selecting input options, and is also equipped with a power/status indicator light.

Furthermore, the warning module 20 further comprises a plurality of beam projection units 21, a plurality of dynamic sensing units 22, a plurality of proximity detection units 23, an audio output unit 24, a plurality of atomization units 25, and a plurality of projection drive units 26. The plurality of beam projection units 21 are installed at the lower of the vehicle's side mirrors according to actual functional requirements. Depending on the size, length, or width of the medium or large vehicle, the driver (or vehicle owner) may optionally install additional beam projection units 21 at midsections of the vehicle body to enhance optimal warning effectiveness. Both the standard beam projection units 21 and the optional expansion ones installed at midsections are secured using dedicated mounting clamps.

Each beam projection unit 21 includes an optical lens and operates in a projection mode to emit a specific warning pattern shape onto the ground through the optical lens, thereby visibly indicating the blind space or zones to alert surrounding pedestrians or vehicles that may be approaching or entering that proximity area.

The plurality of dynamic sensing units 22 are embedded within the warning module 20 and are capable of sensing dynamic quantitative data from various parts of the vehicle, such as GPS positions, velocity or acceleration. This data is transmitted to the previously described control module 10 for calculating the conditions necessary to trigger the laser beam projection and/or generate an auditory sound.

The plurality of proximity detection units 23 are configured to sense whether persons, vehicles, or objects are approaching or intruding into the predefined blind spot zones/area. And, those plurality of proximity detection units 23 can utilize infrared, ultrasonic, or radar-based sensors to detect nearby objects. The sensing data is transmitted to the control module 10 to determine the appropriate timing for activating beam projection.

The plurality of mist spreading units 25 are installed in coordination with the beam projection units 21. These mist spreading units 25 release water mist in the direction of the beam projection, utilizing the Tyndall effect to enhance the visibility and warning effectiveness of the laser beams.

The plurality of projection drive units 26 include drive motors or other functionally equivalent power components designed to support and adjust the angle or direction of the beam projection units 21. These projection drive units 26 receive operational commands from the control module 10 via either the input/output operation unit 13 or the wireless control unit 12 through application software, allowing for adjustment of the projection angle and direction.

The audio output unit 24 generates corresponding audible warnings based on various beam projection activation conditions as determined by the system of the present invention.

Each beam projection unit 21 includes an optical lens and operates in a projection mode to emit a specific warning pattern shape onto the ground through the optical lens, thereby visibly indicating the space encompassing the driver's visual blind spot, and warning nearby pedestrians or vehicles that may be approaching or entering that area.

The plurality of dynamic sensing units 22 are embedded within the warning module 20 and are capable of sensing dynamic quantitative data from various parts of the vehicle. This data is transmitted to the previously described control module 10 for calculating the conditions necessary to trigger the laser beam projection. The plurality of proximity detection units 23 are configured to sense whether persons, vehicles, or objects are approaching or intruding into the predefined blind spot area. The sensing data is transmitted to the control module 10 to determine the appropriate timing for activating beam projection. The plurality of atomization units 25 are installed in coordination with the beam projection units 21. These atomization units release water mist in the direction of the beam projection, utilizing the Tyndall effect to enhance the visibility and warning effectiveness of the laser beams. The plurality of projection drive units 26 include drive motors or other functionally equivalent power components designed to support and adjust the beam projection units 21. These drive units receive operational commands from the control module 10 via either the operation input unit 13 or the wireless control unit 12 through application software, allowing for adjustment of the projection angle and direction. The audio output unit 24 generates corresponding audible warnings based on various beam projection activation conditions as determined by the system of the present invention.

The primary objective of the present invention is to provide a light beam marking system and method for vehicle visual blind zones 1, whose main system structure comprises an integrated design of a control module 10 and a warning module 20. The wireless control unit 11 of the control module 10 is further configured to perform bidirectional data transmission with a handheld communication device via a dedicated application software, enabling firmware updates, system log access, and device registration synchronization. This facilitates fine-tuning of various customized optical parameters within the system, such as: sensitivity settings for the approach detection unit 23 of the warning module 20 regarding human/vehicle/object proximity within the visual blind zones/area, beam projection modes, projection durations and projection angle/direction.

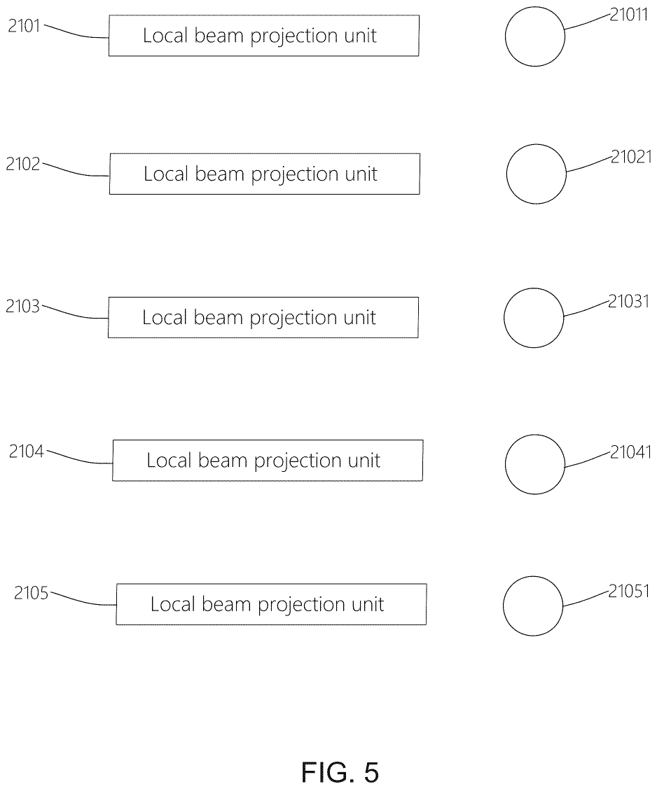

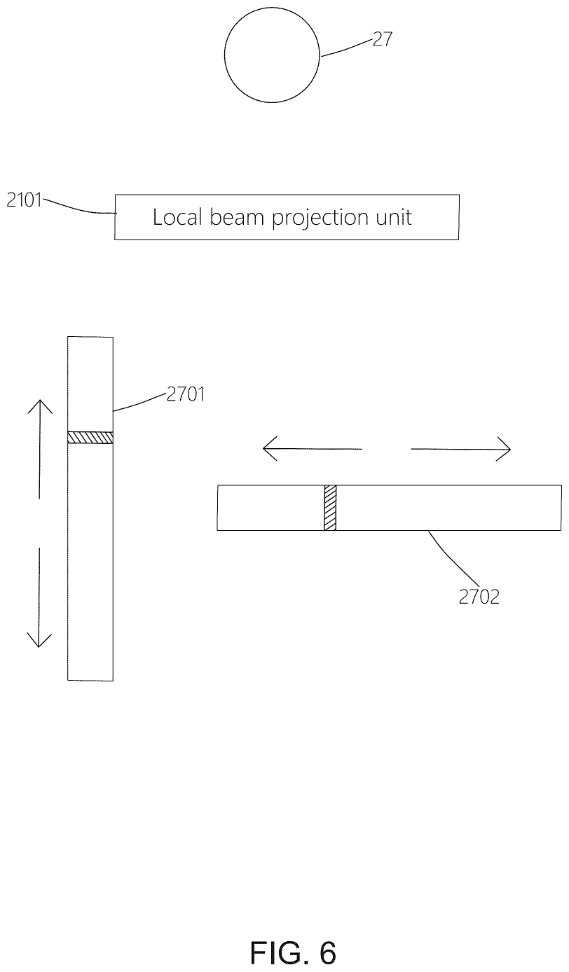

Moreover, the wireless control unit 11 of the control module 10 can establish a connection with a handheld communication device (not shown in drawings) through Bluetooth mode using the dedicated application software (App), thereby allowing the driver to earlier adjust the system more precisely according to their posture and line of sight while driving. The application interface includes at least one main page and multiple subpages. (Please refer to FIGS. 5 and 6) The above-mentioned a plurality of beam projection units 21 are separated into several local beam projection unit 2101, 2102, 2103, 2104, 2105 according to its installed position and listed on the at least one main page. Each local beam projection unit 2101, 2102, 2103, 2104, 2105 can be selected by touching its corresponding access button 21011, 21021, 21031, 21041 or 21051 to enter the associated subpage. For example, entering through the main page and touching the access button 21011, the control interface comes into the subpage of local beam projection unit 2101. That subpage comprises a touch camera button 27 at the upper part, and a pair of projection angle scroll bar 2701 and projection direction scroll bar 2702 at a lower position. By moving the scroll bars, the beam projection angle or direction can be tuned conveniently in wireless mode.

To explain in more details, the application software provides two methods for adjusting the beam projection area/zones, as described below:
Page Control Adjustment: The projection angle or direction can be adjusted by using the at least one main page and multiple subpages; and
Semi-Automatic Adjustment: First, entering the associated subpage according to which local beam projection unit 2101, 2102, 2103, 2104, 2105 will be adjusted, the App will enter Semi-Automatic Adjustment status. Then, the driver has to hold the handheld device so that the camera view on the screen can align with the simulated driver's field of vision which is seen from the driver's seat. The warning module 20 initially resets all projection settings to default values and begins an optimal processing for beam projection angle and direction. During this process, the app will capture at least three images per second through the handheld device's camera. These images are then processed into binarized (black-and-white) images for comparative analysis to determine whether the projected beam accurately reaches the boundary of the visual blind zones. Once confirmed, the system records the configuration parameters of the beam projection unit 2101. Upon each time system startup, it will verify whether the stored parameters of each beam projection unit 2101, 2102, 2103, 2104, 2105 in the warning module 20 match the previously set values. If inconsistencies are detected, the system will alert and notice the driver which local beam projection unit 2101, 2102, 2103, 2104, 2105 needs to be reconfigured its adjustment.

Through the detailed description provided above, a person skilled in the art would appreciate that the purpose of the present invention can surely be realized with the technical solution of the present invention and thus, the present invention generally meets all postulated requirement of patent laws and regulations. And, as such a patent application is thus filed with the invention.

However, it is appreciated that the above description provides just preferred embodiments of the present invention and the description is not intended to impose constraint to the scope of the present invention that protection is sought through the appended claims. Thus, all the variations and modifications that are believed equivalent to the present invention according to wheat described and defined in the above specification and the appended claims should be regarded within the scope of protection covered by the present invention.

What is claimed is:

1. A light beam marking system for vehicle visual blind zones, comprising:
a control module, installed within a vehicle, further comprising:
a wired control unit, configured to communicate with external devices via data ports and to transmit control signals to a warning module;
a wireless control unit, configured to wirelessly connect with an external handheld communication device via a dedicated application software for system control and firmware updates; and
an input/output operation unit including physical input elements and status indicators;
a warning module, operatively connected to the control module, further comprising:
a plurality of beam projection units, each configured to emit a warning beam with a specific pattern onto the ground through an optical lens, wherein the beam projection units are installed at the lower of side mirror or midsections of a vehicle body;
a plurality of dynamic sensing units, configured to detect vehicle motion parameters and transmit the sensed data to the control module;
a plurality of proximity detection units, configured to detect the presence of persons, vehicles, or objects approaching a predefined blind zone and transmit corresponding data to the control module;
a plurality of mist spreading units, disposed near the beam projection units, configured to spread mist in a direction corresponding to the beam projection units to enhance beam visibility via the Tyndall effect;
a plurality of projection drive units, each configured to adjust the direction and angle of a corresponding beam projection unit based on control signals from the control module; and
an audio output unit, configured to output an audible warning in response to system-determined projection conditions.

2. The system of claim 1, wherein each beam projection unit includes an optical lens that projects a laser beam forming a predefined pattern representing the blind zone boundary.

3. The system of claim 1, wherein the beam projection units are fixed using dedicated clamps that allow for modular installation and removal.

4. The system of claim 1, wherein the dynamic sensing units include sensors to detect velocity, acceleration, or GPS data.

5. The system of claim 1, wherein the proximity detection units utilize infrared, ultrasonic, or radar-based sensors to detect nearby objects.

6. The system of claim 1, wherein the mist spreading units emit fine water mist to scatter light and make the projected beam more visible.

7. The system of claim 1, wherein the wireless control unit uses Bluetooth to pair with the external handheld communication device.

8. The system of claim 1, wherein the dedicated application software includes a graphical user interface with at least one main page and a plurality of subpages, each corresponding to an individual beam projection unit.

9. The system of claim 8, wherein the subpages comprise user interface elements for adjusting the projection angle and direction via scroll bars.

10. The system of claim 1, wherein the dedicated application software supports semi-automatic adjustment by capturing real-time images through the handheld device's camera and processing them into binarized data for calibration.

11. The system of claim 10, wherein the application software captures at least three images per second to assess the projection position during the semi-automatic calibration process.

12. The system of claim 1, wherein the control module performs a parameter consistency check during system startup and alerts the driver if any beam projection unit's settings differ from the previously stored configuration.

13. The system of claim 1, wherein the audio output unit provides different audible warnings depending on the severity or type of detected intrusion into the blind zone.

14. The system of claim 1, wherein the system supports firmware updates and log data transmission via both the wired and wireless control units.

15. The system of claim 1, wherein the control module allows for user-customized configuration of sensitivity levels, beam projection duration, angle, and mode through the application software.

16. A method for marking vehicle visual blind zones using a light beam projection system, comprising the steps of:
providing a control module and a warning module installed in a vehicle;
detecting proximity of persons, vehicles, or objects entering a predefined blind zone using a plurality of proximity detection units;
detecting dynamic vehicle parameters via a plurality of dynamic sensing units and transmitting the data to the control module;
calculating a triggering condition based on proximity and dynamic data to activate one or more beam projection units;
emitting a beam pattern onto the ground surface by the activated beam projection units to visually indicate the blind zone;
enhancing visibility of the beam using atomization units that emit mist in the beam's path to create a Tyndall effect; and
generating an audible warning via an audio output unit based on the triggering condition.

17. The method of claim 16, further comprising:
connecting the control module to a handheld communication device using Bluetooth;
and using an application software to wirelessly adjust beam projection parameters including projection angle, direction, and duration.

18. The method of claim 16, further comprising:
receiving system configuration updates or firmware updates through either wired or wireless connections.

19. The method of claim 16, wherein the application software includes a semi-automatic adjustment mode that comprises:
capturing real-time images via the handheld device's camera while aligned with the driver's field of view;
processing captured images into binarized formats;
comparing successive images to determine the visibility of the projected beam on blind zone boundaries; and
adjusting projection parameters based on the result.

20. The method of claim 16, further comprising verifying, upon system startup, whether stored projection parameters match previously set values, and alerting the driver if discrepancies are detected.
